(19) United States
(12) Patent Application Publication
(10) Pub. No.: US 2020/0402065 A1
(43) Pub. Date: Dec. 24, 2020

(54) FEDERATED EDGE-NODE AUTHORIZATION SYSTEM

(71) Applicant: Bank of America Corporation, Charlotte, NC (US)

(72) Inventors: Monika Kapur, Jacksonville, FL (US); Siten Sanghvi, Jersey City, NJ (US); Brandon Sloane, Charlotte, NC (US); Kevin A. Delson, Woodland Hills, CA (US); Albena N. Fairchild, Indian Trail, NC (US); John Ryan Bowling, Mooresville, NC (US); Ryan Davis, Charlotte, NC (US)

(21) Appl. No.: 16/448,087

(22) Filed: Jun. 21, 2019

(51) Int. Cl. G06Q 20/40; G06Q 20/32; G06Q 20/20

(52) U.S. Cl. CPC G06Q 20/40145; G06Q 20/20; G06Q 20/3278; G06Q 20/3224

(57) ABSTRACT

Apparatus and methods for a federated edge-node computing system are provided. The federated system may allow customers to work in offline mode (e.g., during a disaster). Local data stored on edge-nodes may be used to process offline transactions. Offline transactions may include money transfers and merchant payments using mobile wallets. A plurality of nodes may form a consortium. The consortium may be formed based on geographic proximity of nodes. Member of the consortium may locally store geographically relevant data for authorizing offline transactions.

### FIELD OF TECHNOLOGY

This application describes apparatus and methods for securing electronic payments using edge-computing during periods when network connections to a cloud computing environment are unavailable.

### BACKGROUND

Typically a customer may initiate an electronic payment or other electronic transaction with a merchant. The electronic payment may include a payment request to transfer an amount of funds to the merchant. In exchange for the amount, the merchant may release desired goods to the customer.

A point-of-sale (“POS”) system at the merchant may receive the electronic payment from the customer. The POS system may submit the electronic payment to a cloud computing environment for processing. Processing may include evaluating whether the payment request should be authorized or denied. Processing may include determining whether the customer has a sufficient cash balance in an account to cover an amount of the electronic payment. Processing may include determining whether the customer has an available line-of-credit to cover an amount of the electronic payment. The processing may include security and fraud detection analyses. The cloud computing environment may provide access to relevant data need to conduct the security and fraud detection analyses.

Although the cloud computing environment may be a robust and resilient system, communication failures between the customer and cloud computing environment or merchant and cloud computing environment may prevent an electronic payment from being timely received and processed by the cloud computing environment. For example, the merchant's POS system may attempt to transfer an electronic payment to the cloud computing environment using telecommunication equipment. A natural disaster may damage the telecommunication equipment, preventing the merchant's POS system or customer mobile device from communicating with the cloud computing environment. The telecommunication equipment may fail, cutting off access to the cloud computing environment.

Typically, when a customer device or merchant POS system cannot communicate with the cloud computing environment, the electronic payment will not be authorized. By default, the merchant POS system may be configured to deny an electronic payment and associated payment request if communication with the cloud computing system is unavailable. When the electronic payment is denied, the merchant may not release goods to the customer. The customer will need to return to the merchant another time to obtain the desired goods.

Aside from customer inconvenience, goods sold by the merchant may be needed by the customer within a predetermined time window. For example, the customer may need fuel for a vehicle or medicine for a family member. It would be desirable to provide apparatus and methods that overcome communication failures that may generate a denial of a payment request. It would further be desirable to provide apparatus and methods that solve technical challenges facing network models that route electronic payments to a cloud computing environment for processing. Accordingly, it would be desirable to provide a federated edge-node authorization system that operates despite communication failures that sever connections to a cloud computing environment.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative system components in accordance with principles of the disclosure;

FIG. 2 shows an illustrative system in accordance with principles of the disclosure;

FIG. 3 shows an illustrative system in accordance with principles of the disclosure;

FIG. 4 shows an illustrative system and scenario in accordance with principles of the disclosure;

FIG. 5 shows an illustrative system in accordance with principles of the disclosure;

FIG. 6 shows an illustrative system in accordance with principles of the disclosure; and

FIG. 7 shows an illustrative process in accordance with principles of the disclosure.

### DETAILED DESCRIPTION

Apparatus and methods for a federated edge-node computing system are provided. An edge-node may be a node on the periphery or edge of a network. An illustrative network may be an internet-of-things (“IoT”) network. An IoT network may include one or more nodes. Each node may include two or more nodes.

A node may be a sensor. A sensor may include devices that detect changes in a physical or virtual attribute of an operating environment. For example sensors may measure attributes such as audio, rainfall, temperature, water levels or activity of other sensors. Sensors may measure electronic network traffic, electronic signals (e.g., input or output) or frequency of user logins within a predefined geographic area.

Nodes may be any suitable size. For example, nodes may be a few millimeters in size. Nodes may be deployed in a wide variety of locations. For example, sensors may be deployed in military battlefields, industrial plants, in orchards, in clothing, automobiles, smartphones, jewelry or refrigerators. Sensors may be relatively inexpensive and have low energy consumption. Sensors may “sense” two or more stimuli or environmental attributes. Nodes may store captured data locally. For example, nodes may store captured data in transitory and/or non-transitory computer readable media.

Nodes may implement two or more functions. For example, sensors may measure changes in their native (physical or virtual) environment, capture data corresponding to the measured changes and store/communicate the captured data. Sensors may be accessed by other sensors or other nodes on the network.

A node may be an actuator. For example, based on data captured by a sensor, an actuator may respond to a detected event. Based on the capture and analysis of multiple sources of data (e.g., captured by sensors), an actuator may be instructed to take action without human intervention.

Actuators may respond to data transmitted or processed by other nodes. Actuators may include devices that modify the physical state of a physical entity. Actuators may include devices that modify a virtual state of information. Actuators may move (translate, rotate, etc.) physical objects or activate/deactivate functionalities of physical objects.

For example, actuators may dim a light bulb, open a door, change a temperature setting, authorize electronic payments and/or any other suitable functionality. Actuators may verify identities, trigger electronic payments, extend credit or debit accounts.

Contextually, data captured by nodes may provide information not only about the native (physical or virtual) operating environment surrounding a node, but capturing data from multiple nodes may provide data that signifies occurrence an event. The data may be analyzed by a cloud computing environment. Analytical tools (e.g., big data analysis techniques) may detect, within the data, occurrence of an event that triggers actuator nodes to take responsive action.

Within an IoT environment, sensor nodes may perform the functions of input devices—they serve as “eyes” collecting information about their native environment. In contrast, actuator nodes may act as “hands” implementing decisions based on data captured by the sensor nodes. A single node may include the functions of sensors and actuators.

A node may transmit data. Captured data may be transmitted to a location where information is needed for decisioning or consumption. Such a location may not be the same location where the data was captured or generated. Nodes may include an application programming interface (“API”) for communicating with other nodes. Nodes may communicate directly with other nodes using machine-to-machine (“M2M”) protocols. Illustrative M2M protocols may include MQ Telemetry Transport (“MQTT”). M2M includes communication between two or more objects without requiring direct human intervention. M2M communications may automate decision-making and communication processes for actuators.

Data captured by a node may be transmitted to another node. A node may transmit data to a network core. The network core may process the data. For example, multiple sensors may transmit captured data to a cloud computing environment. The cloud computing environment may itself include multiple nodes, such as computer servers, database or other computer systems. Nodes of the cloud computing environment may be networked to each other. Data synchronization protocols and caching techniques may be deployed across an IoT network to facilitate transmission of, or delivery to, desired nodes.

The cloud computing environment may process data captured by other nodes far from the location where the data was captured. For example, captured data may be transmitted from one node to another node until the captured data reaches a centrally located data depository.

Data captured by nodes in an operating environment may be voluminous and complex (e.g., structured/unstructured and/or constantly changing). Traditional data processing application software may be inadequate to meaningfully process the data (e.g., “big data”). A cloud computing environment may include software applications specially designed to process large volumes of data (“big data analytics”).

Nodes may communicate with other nodes directly, without transmitting information to an intermediary node or central server, such as a cloud computing environment. Data may be transmitted by a node using any suitable transmission method. For example, data captured by a node may be transmitted via a cellular network to a smartphone. Nodes may leverage a communication link provided by the smartphone to communicate captured data to other nodes. A location where data is captured may not have continuous, reliable network connectivity. Accordingly, captured data may be stored locally on the node until a network connection is available to transmit or broadcast the captured data to another node.

As a result of the disparate nature of nodes, an operating environment may support a variety of communication protocols. Illustrative supported protocols may include HyperText Transfer Protocol (“HTTP”), Simple Object Access Protocol (“SOAP”), REpresentational State Transfer (“REST”) Constrained Application Protocol (“CoAP”), SensorML, Institute of Electrical and Electronic Engineers (“IEEE”) 802.15.4 (“ZigBee”) based protocols, IEEE 802.11 based protocols. For example, ZigBee is particularly useful for low-power transmission and requires approximately 20 to 60 milli-watts (“mW”) of power to provide 1 mW transmission power over a range of 10 to 100 meters and a data transmission rate of 250 kilo-bits/second.

To further conserve energy, a node may communicate wirelessly for short periods of time. Utilizing this approach, one or more standard size single cell dry battery batteries (e.g., AA size) may provide a node with requisite computing power and wireless communication for many months.

A physical layer may link nodes within an operating environment. The physical layer may provide data ports and communication pathways to move data between multiple sub-networks and nodes. Such communication pathways may be wired or wireless. Exemplary wireless communication pathways may include Bluetooth, Wi-Fi, 3G, 4G, 5G and any other suitable wired or wireless broadband standards. Illustrative data ports of nodes may include hardware and/or software to receive and/or transmit data using any suitable communication pathway.

Each node may be assigned a unique identifier. For example, nodes may be identified by one or more radio frequency identification (“RFID”) tags. The RFID tag may be stimulated to transmit identity information about the node or any other information stored on the RFID tag. Nodes may be identified by an Internet Protocol (“IP”) address.

Nodes may be grouped. Nodes may be grouped based on physical proximity to each other or based on function, such as content (or expected content) of data captured by a node. Nodes may be grouped virtually. A group of nodes may be termed a consortium. Nodes may be dynamically connected or disconnected from a group or consortium of nodes.

Advances in embedded systems, such as System-on-a-Chip (“SoC”) architectures, have fueled development of nodes that are powerful enough themselves to run operating systems and complex data analysis algorithms. An illustrative SoC may include a central processing unit (“CPU”), a graphics processor (“GPU”), memory, power management circuits, and communication circuit (Wi-Fi, 3G, 4G LTE, 5G). Such nodes may be positioned closer (relative to the cloud computing environment) to other data gathering nodes such as sensors on an IoT network. Nodes that are positioned close to the source of data being processed and having sufficient computational power to process data may be termed “edge-nodes.” Edge-nodes may integrate sensing capabilities, actuating capabilities, data connectivity and/or computing capabilities.

Edge-nodes may control sensors, actuators, embedded devices and other nodes. Edge-nodes, or the nodes they control, may not be continuously connected to a network. Edge-nodes may provide increased computational resources positioned near the source of captured data or near an operating environment. Processing data using edge-nodes may reduce the communication bandwidth needed to transmit data from a node to a cloud computing environment.

For example, a sensor deployed among turbines in a windfarm may detect changes in wind speed or wind direction. Typically, the sensor may transmit detected changes to a remote cloud computing environment. The remote cloud computing environment may process data received from the node (and others) and issue instructions to adjust a position of a turbine in response to the detected changes. However, communication with, and processing by, the cloud computing environment may inject additional latency before the turbine is adjusted in response to sensed changes.

By running data analytics and processing closer to the originating source of data, actuator response times may be improved. Edge-nodes embedded in a turbine may include sufficient processing power to analyze sensed data and adjust the turbine to optimize electricity production of the turbine with less latency.

In addition to providing faster response time to sensed changes in operating environmental conditions, processing data using edge-nodes may reduce communication bandwidth requirements and improve overall data transfer time. Furthermore, less frequent data transmissions enhance security of data gathered by nodes. Frequent data transfers may expose more data to more security threats. For example, transmitted data may be vulnerable to being intercepted while en-route to a cloud computing environment.

Because edge-nodes are tasked with decision-making, non-essential data may never need to be transmitted or stored in the cloud computing environment, further reducing exposure of such data to security threats.

For example, network of security cameras may generate large amounts of video data. Transmitting such large amounts of video data to a cloud computing environment may utilize significant bandwidth—possibly preventing the cloud computing environment from timely receiving other time sensitive data. Edge-nodes may analyze the video data at the source. The analysis may save “important” footage and discard the rest. Only important footage may be transmitted to the cloud computing environment, reducing network congestion.

For some applications, reliability and critical-path control management make it undesirable to wait for the cloud computing environment to process data and issue responsive instructions. Instructions to actuators may need to be issued in milliseconds or faster. Round-trip communication to a cloud computing environment introduces undesirable latency.

For example, an anti-collision algorithm for an autonomous vehicle may be executed by the cloud computing environment. However, it would be faster and more reliable for the anti-collision algorithm to be run by edge-nodes. Furthermore, anti-collision data may only have short-term value. It is therefore undesirable to regularly transmit anti-collision data to the cloud computing environment.

Some nodes may be deployed in areas with poor network connectivity. For example, industries such as mining, oil/gas, chemicals and shipping may not be well served by robust affordable communication infrastructure. Incorporating edge-nodes may allow networks associated with these industries to operate without robust communication infrastructure.

Smartphones may not have access to continuous data connections. Edge-nodes may allow a cached version of a website to be opened on a smartphone, without an internet connection. Data may be entered into the website and changes saved locally to the edge-node (e.g., the smartphone itself). The edge-node may synchronize the changes with the cloud computing environment when a data connection is available. Sensor data may be aggregated by an edge-node and transmitted to the cloud computing environment at designated times.

Utilizing edge-nodes may improve security of a network. For example, a network breach may be detected by an edge-node. The intrusion may be quarantined by or at the edge-node and prevent the breach from compromising the entire network. Edge-nodes may run encryption algorithms and store biometric information locally. Such dispersion of sensitive data may reduce risk any one users information may be comprised. Dispersing processing power needed to run encryption algorithms may reduce likelihood encryption algorithms fail to run.

Utilizing edge-nodes may improve reliability of a network. For example, edge-nodes with machine learning capabilities may detect operational degradation in nodes, equipment and associated infrastructure. Such degradation may be detected and cured before developing into a complete operation failure.

Generally, edge-nodes may include a processor circuit. The processor circuit may control overall operation of an edge-node and its associated components. A processor circuit may include hardware, such as one or more integrated circuits that form a chipset. The hardware may include digital or analog logic circuitry configured to perform any suitable (e.g., logical) operation.

A edge-node may include one or more of the following components: I/O circuitry, which may include a transmitter device and a receiver device and may interface with fiber optic cable, coaxial cable, telephone lines, wireless devices, physical layer hardware, a keypad/display control device or any other suitable encoded media or devices; peripheral devices, which may include counter timers, real-time timers, power-on reset generators or any other suitable peripheral devices; a logical processing device, which may compute data structural information, structural parameters of the data, quantify indices; and machine-readable memory.

Machine-readable memory may be configured to store, in machine-readable data structures: captured data, electronic signatures of biometric features or any other suitable information or data structures. Components of a node may be linked by a system bus, wirelessly or by other suitable interconnections. Edge-node components may be present on one or more circuit boards. In some embodiments, the components may be integrated into a single chip forming a SoC. The chip may be silicon-based.

The node may include RAM, ROM, an input/output (“I/O”) module and a non-transitory or non-volatile memory. The I/O module may include a microphone, button and/or touch screen which may accept user-provided input. The I/O module may include one or more of a speaker for providing audio output and a video display for providing textual, audiovisual and/or graphical output.

Software applications may be stored within the non-transitory memory and/or other storage medium. Software applications may provide instructions to the processor that enable an edge-node to perform various functions. For example, the non-transitory memory may store software applications used by an edge-node, such as an operating system, application programs, and an associated database. Alternatively, some or all of computer executable instructions of an edge-node may be embodied in hardware or firmware components of the edge-node.

Software application programs, which may be used by an edge-node, may include computer executable instructions for invoking user functionality related to communication, such as email, short message service (“SMS”), and voice input and speech recognition applications. Software application programs may utilize one or more algorithms that process data, execute instructions, perform power management routines or other suitable tasks.

An edge-node may support establishing network connections to one or more remote nodes. Such remote nodes may be sensors, actuators or other computing devices. Edge-nodes may be personal computers or servers. An edge-node may communicate with other nodes using a data port. The data port may include a network interface or adapter. The communication circuit may include the modem. The data port may include a communication circuit. An edge-node may include a modem, antenna or other communication circuitry for establishing communications over a network, such as the Internet. The communication circuit may include the network interface or adapter.

Via the data port and associated communication circuitry, an edge-node may access network connections and communication pathways external to the edge-node. Illustrative network connections may include a local area network (“LAN”) and a wide area network (“WAN”), and may also include other networks. Illustrative communication pathways may include Wi-Fi, wired connections, Bluetooth, cellular networks, satellite links, radio waves, fiber optic or any other suitable medium for carrying signals.

The existence of any of various well-known protocols such as TCP/IP, Ethernet, FTP, HTTP and the like is presumed, and a node can be operated in a client-server configuration to permit a user to retrieve web pages from a web-based server. Web browsers can be used to display and manipulate data on web pages.

Edge-nodes may include various other components, such as a display, battery, speaker, and antennas. Edge-nodes may be portable devices such as a laptop, tablet, smartphone, other “smart” devices (e.g., watches, eyeglasses, clothing having embedded electronic circuitry) or any other suitable device for receiving, storing, transmitting and/or displaying electronic information.

An edge-node may include a display constructed using organic light emitting diode (“OLED”) technology. OLED technology may enhance functionality of an edge-node. OLEDs are typically solid-state semiconductors constructed from a thin film of organic material. OLEDs emit light when electricity is applied across the thin film of organic material. Because OLEDs are constructed using organic materials, OLEDs may be safely disposed without excessive harm to the environment.

Furthermore, OLEDs may be used to construct a display that consumes less power compared to other display technologies. For example, in a Liquid Crystal Display, power must be supplied to the entire backlight, even to illuminate one pixel in the display. In contrast, an OLED display does not necessarily include a backlight. Furthermore, in an OLED display, preferably, only the illuminated pixel draws power.

The power efficiency of OLED technology presents a possibility for designing edge-nodes that consume less power for their basic functionality and allow any residual available power to provide enhanced security and functionality. Illustrative devices that may be constructed using OLED technology are disclosed in commonly assigned U.S. Pat. No. 9,665,818, which is hereby incorporated by reference herein in its entirety.

An edge-node may be, and may be operational with, numerous other general purpose or special purpose computing system environments or configurations. Examples of well-known computing systems, environments, and/or configurations that may be suitable for use with this disclosure include, but are not limited to, personal computers, server computers, handheld or laptop devices, tablets, “smart” devices (e.g., watches, eyeglasses, clothing having embedded electronic circuitry) mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Edge-nodes may utilize computer-executable instructions, such as program modules, executed by a processor. Generally, program modules include routines, programs, objects, components, data structures, etc. that perform particular tasks or implement particular abstract data types. An edge-node may be operational with distributed computing environments where tasks are performed by remote processing devices that are linked through a communications network. In a distributed computing environment, program modules may be located in both local and remote computer storage media including memory storage devices. Edge-nodes may interact with a network of remote servers hosted on the Internet to store, manage, and process data (e.g., a cloud computing environment).

Edge-nodes may include a battery. The battery may be a power source for electronic components of the edge-node. For example, the battery may supply power to the display, the communication circuit and the processor circuit. In some embodiments, an edge-node may include a plurality of batteries. Edge-nodes may include solar panels that convert solar energy into electricity that power one or more components of an edge-node.

An edge-node may receive data in real-time or at pre-defined intervals, such as once a day. The edge-node may filter data captured by one or more nodes. The edge-node may repackage or reformat captured data. Data conversion may include transformation of low level raw data (possibly from multiple sensors or groups of sensors) into meaningful information for a specific audience or for a specific analysis.

For example, captured data intended for human consumption or interaction may be converted into a human understandable format. Captured data intended for machine consumption may be converted into a format readable by a particular machine or node.

The edge-node may process data and perform pattern recognition to identify correlations and trends in captured data. The edge-node may evaluate a cost of obtaining data. “Costs” may be monetary (e.g., labor costs or infrastructure costs), time-related or related to a level of intrusion needed to obtain desired data. “Costs” may be bandwidth-related.

For example, a communication pathway may be associated with a fixed bandwidth. A communication pathway may include nodes and network connectivity linking those nodes. The bandwidth may limit an amount of information or a rate of transmission over the communication pathway. As further example, a node may respond slowly to a request from another node if there is a large amount of informational traffic traveling on a communication pathway shared with other nodes. The large amount of informational traffic may not leave sufficient bandwidth for the transmitting node to timely communicate with the requesting node.

As a further example, a node may respond slowly if the node transmits a large amount of captured data. If transmitted all at once, the large amount of information transmitted by the node, together with other informational traffic traveling on a shared communication pathway, may be close to, or exceed bandwidth of the communication pathway. As a result, the network may become congested and other nodes on an IoT may be unable to transmit time-sensitive captured data in a timely manner.

Data travelling within an operating environment to/from nodes may be routed along multiple communication pathways until the transmitted information reaches a desired destination node (e.g., a cloud computing environment). Each communication pathway may service a number of connected nodes and a respective volume of informational traffic.

It may be difficult to ascertain available bandwidth on a particular communication pathway. It may be difficult to ascertain which communication pathways are being utilized to transmit information between nodes. Nodes attempting to transmit information over a communication pathway may not be aware of a number of connected nodes, a volume of traffic on a particular communication pathway or a bandwidth capacity of a communication pathway.

Furthermore, a communication pathway may be controlled by a different entity from an entity responsible for operation of a particular node. The entity responsible for operation of the node may be unable to monitor a number of nodes that share a communication pathway, a bandwidth capacity of a communication pathway or a volume of traffic transmitted on a communication pathway. Edge-node may be configured to manage data transmission of other nodes to reduce network congestion. For example, an edge-node may perform pattern recognition to estimate costs of obtaining data from a remote node on an IoT.

A federated computing system may provide a technical solution that maintains operation of a computing system despite a communication disruption between components of the computer system. The federated computing system may include a cloud computing environment. The cloud computing environment may maintain a central ledger. The central ledger may record transactions between customers and merchants. Each transaction may include a payment request to debit an account balance of a customer for a cost of goods sold by the merchant. The payment request may include a request to draw down a line-of-credit available to the customer in exchange for releasing the goods to the customer. The central ledger may record transaction attributes associated with the transactions. Illustrative attributes are shown below in Table 1.

The cloud computing environment may include payment request authorization software. The cloud computing environment may run the payment request authorization software. The payment request authorization software may be configured to determine whether to authorize a payment request. The payment request software may authorize the payment request based on data included in the central ledger. For example, the software may check a customer's available account balance. If the account balance is greater than or equal to an amount of the payment request, the software may authorize the payment request. In response to authorizing the payment request, the account balance of the customer may be debited.

The authorization software may evaluate a customer's available line-of-credit. If sufficient credit is available to cover the amount of the payment request, the software may authorize the payment request. In response to authorizing the payment request, the software may draw down the line-of-credit.

Subcomponents of the federated system may autonomously break-off from the larger system and form a consortium. Each subcomponent may include one or more nodes. Subcomponents may include edge-nodes. Subcomponents may be configured to form the consortium based on geographic proximity. Geographic proximity may include a relative location of each subcomponent. Geographic proximity may include a location where data is captured or stored.

Formation of a consortium may provide localized functionality typically globally provided by other components the federated computer system. Such localized functionality may include authorization processing of electronic payments. Localized functionality may include authorization processing despite subcomponents being unable to communicate with the cloud computing environment.

For example, the consortium may form in response to a natural disaster that prevents subcomponents from connecting to the cloud computing environment. The consortium may be configured to process electronic payments without communicating with the cloud computing environment. Electronic payments that are not processed using communication with the cloud computing environment may be termed “offline payments.”

Processing an offline payment may include determining whether to authorize the offline payment. Processing an offline payment may include recording an authorization decision for the offline payment. Processing an offline payment may include communicating with a merchant POS system and instructing the merchant POS system to release goods in response to an authorization decision.

Subsets of data collectively stored within the cloud computing environment may be dispersed and stored locally on one or more edge-nodes. Subsets of data may be stored on an edge-node that is expected to be geographically close to an origination location of an offline electronic payment that may need to be processed using the subset of data.

Processing electronic payments using the edge-node members of the consortium may allow for offline payments to be processed close to where an electronic payment originates. Processing offline payments using edge-nodes may secure data associated with the electronic payment and reduce latency for processing for such transactions.

Offline payments may leverage authentication routines provided by one or more edge-nodes. Such authentication routines may secure electronic payments and prevent unauthorized use of customer funds or credit.

For example, an edge-node may be a customer's mobile device. A merchant POS terminal may be an edge-node. The merchant POS terminal may formulate an electronic payment and attempt to forward that electronic payment to the cloud computing environment for authorization. If a connection to the cloud computing environment is not available, the merchant POS terminal may attempt to authorize the now offline payment using an autonomously formed consortium of edge-nodes. The consortium may include the merchant POS terminal and the customer's mobile device.

The merchant POS terminal may communicate with the customer's mobile device using any suitable communication hardware and/or software. For example, the terminal and mobile device may communicate using near field communication (“NFC”), Bluetooth or Wi-Fi. The merchant POS terminal may access data stored locally on the mobile device. The merchant POS terminal may prompt the customer to authenticate the offline payment using a biometric (e.g., facial, retina, fingerprint) credentials submitted to and verified by the mobile device.

One or more of the edge-nodes may apply security and fraud detection analyses to an electronic payment (online or offline). For example, an edge-node may request customer authentication before attempting to forward an electronic payment a cloud computing environment. The edge-node may evaluate one or more attributes associated with an electronic payment. An offline payment for a relatively small amount may be authorized and an offline payment for a larger amount may be subject to closer scrutiny.

For example, the edge-nodes may compare payment attributes of the offline payment to locally stored attributes associated with historical electronic payments. For online payments, edge-nodes may apply an escalation process where if an authorization decision can't be made locally by the edge-node, decisioning will be escalated up to the cloud computing environment.

Electronic payments (online or offline) may include money transfers, payments to merchants, stock transactions or trading of other assets. For offline payments, if a cloud computing environment is not available, a locally stored cached version of a website or trading prices may be pushed to the customer's mobile device. A notification that the information is cached may also be provided to the customer. Offline payments may be processed based on estimated time of disconnection from the cloud computing environment.

The customer may execute an offline payment using cached information. When a cloud computing environment comes back online, the executed offline payment may be synchronized with data available to the cloud computing environment. Offline payments processed by an edge-node or consortium of edge-nodes may be encrypted before or after authorization. Offline payments may be secured by recording offline payments using a distributed ledger. A distributed ledger may employ hashing/blockchain technology. The edge-nodes may execute a consensus algorithm to confirm offline payments that will be recorded in the distributed ledger. Offline payments recorded in the distributed ledger may be deemed authorized.

Each edge-node member of a consortium may include algorithms, such as a consensus protocol, for confirming offline payments that will be recorded in the distributed ledger. The consensus protocol may also be used to authorize an offline payment without a connection to the cloud computing environment. The consensus protocol may allow the consortium to leverage subsets of data stored locally on edge-nodes. The consensus protocol may allow the edge-node members of the consortium to leverage their collective functionality, such as processing power, to process payments that would typically require resources of a cloud computing environment.

The consensus protocol may establish a threshold level of trust that an offline payment has been processed by an edge-node. Illustrative consensus protocols may include a proof of work protocol, a proof of stake protocol, a delegated proof of stake protocol, a transaction as proof of stake protocol and a delegated byzantine fault tolerance protocol. Any suitable consensus protocol may be utilized. A consensus protocol may prevent a malicious node from attempting to record an unauthorized electronic payment.

In some embodiments, the consortium may attempt to process an electronic payment before attempting to submit the payment to the cloud computing environment. The consortium may attempt to process the electronic payment even if a connection to the cloud computing environment is available.

A consortium may be formed of edge-node members within a predetermined distance of an origination location of an electronic payment. Processing the electronic payment using the consortium may reduce latency and provide faster processing times. If the consortium is unable to process the electronic payment, the consortium may then submit the electronic payment to the cloud computing environment for processing.

Methods may include detecting electronic payments that are eligible for processing by the consortium. Such electronic payment may be associated with a specific customer, specific account, specific goods or any other suitable transaction attribute. Illustrative transaction attributes are shown below in Table 1.

TABLE 1
Illustrative transaction attributes and associated values.

| Illustrative | Illustrative |
|---|---|
| Transaction | Associated |
| Attributes | Value |
| Geographic | Longitude/latitude |
| | GPS coordinates |
| | Map coordinates |
| | Elevation |
| | Depth |
| | Distance from a point |
| | Home address |
| | Work address |
| | Typical transit pathway |
| | Zip code |
| | Area code |
| | County |
| | State |
| | Country |
| | IP address |
| | Signal triangulation location |
| Temporal | Seconds |
| | Minutes |
| | Hours |
| | Day |
| | Week |
| | Month |
| | Year |
| | Duration |
| | Purchase frequency |
| Synoptic | Correlation among two |
| | or more attributes |
| | Logical explanation for outlier |
| | purchase (e.g., weather, time of |
| | year, current events, ect . . .) |
| Transaction | Dollars |
| amount | Available credit |
| | Currency |
| | Foreign exchange rate |
| | Low value purchase |
| Number of | Number |
| items purchased | Number of distinct |
| | stock keeping units |
| | (“SKU”) |
| Merchant | Numerical identifier |
| category code | Taxation status |
| | Type of goods sold |
| Payment instrument | Brand |
| identifier | Rewards |
| | Transaction Network |
| | Issuer |
| | Affinity |
| Loyalty | Rewards/point balance |
| program | Membership level |
| | Duration of membership |
| | Frequency of use |
| Access | Point-of-sale |
| Channel | Automated teller machine |
| | Online portal |
| | Self-service kiosk |
| | Mobile device |
| | In person |
| | Airport kiosk |
| | Border Control kiosk |

Apparatus and methods for a federated edge-node authorization system are provided. The system may include a first edge-node. The first-edge node may create a payment request. For example, the first-edge node may obtain an amount and identification of goods from a merchant POS system. The first edge-node may obtain payment instrument information from a customer device. The first edge-node may be configured to receive a payment request generated by another device or system.

The first edge-node may be a mobile device. The first edge-node may be a merchant POS terminal or other component of a merchant POS system. The first-edge node may attempt to transmit the payment request to the cloud computing environment for processing.

When the cloud computing environment acknowledges receipt of the payment request within a predetermined time period, the first edge-node may wait to receive an authorization decision from the payment request authorization software. In response to receiving the authorization decision, the first edge-node may trigger release of the goods associated with the payment request. The first edge-node may communicate with the merchant POS system and trigger release of the goods.

The first edge-node may not be able to establish a connection to the cloud computing environment. The cloud computing environment may fail to acknowledge receipt of the payment request within the predetermined time period. When a communication failure is detected, the first edge-node may attempt to locate a second edge-node. The first edge-node may search for a second edge-node storing a fragment of the central ledger.

The fragment may include a cached subset of information stored in a central ledger. The fragment may include cached data associated with a geographic location of the edge-node storing the fragment. For example, based on a geographic location of an edge-node (e.g., GPS coordinates), entries of a central ledger that include geographic attributes within a predetermined radius of the edge-node may be stored locally on the edge-node. The entries stored locally on the edge-node may constitute a fragment of the central ledger.

The fragment may include a cached balance associated with the customer account. The fragment may include cached data indicating credit available to the customer. In some embodiments, the first edge-node itself may store the fragment.

The first edge-node may be further configured to authorize the offline payment request based on the cached balance or other information (e.g., attributes) included in the fragment. The first edge-node may trigger release of goods in response to authorizing the offline payment based on the cached balance or other information included in the fragment.

When a cloud computing environment issues an authorization decision, a first set of authorization restrictions may be imposed. The first set of authorization restrictions may be based on data available within the central ledger. When an edge-node authorizes an offline payment based on the locally stored fragment, a second set of authorization restrictions may be imposed. The second set of authorization restrictions may be more restrictive than the first set. The second set of authorization restrictions may account for a possibility that data in the locally stored fragment is outdated.

For example, the second set of authorization restrictions may limit a value of the goods. The second set of authorization restrictions may limit on a number of payment requests that may be authorized based on a locally stored fragment. The second set of authorization restrictions may limit on a geographic location of the first edge-node. The second set of authorization restrictions may require that the first edge-node be located within a defined distance of a customer's home, office or other landmark known to be associated with the customer. The second set of authorization restrictions may require that attributes associated with the offline payment fit into a pattern of transactions. The pattern of transactions may be determined based on analysis of attributes included in the fragment.

Restrictions may be system set. For example, machine learning algorithms may determine and impose restrictions. In some embodiments, restrictions may be set by a customer or merchant. For example, a customer may set a purchase value limit on offline payments that may be authorized. Offline payments that exceed the purchase value limit may be denied.

The first edge-node may be configured record authorization of the offline payment request based on the fragment. The authorization based on the fragment may be recorded by transmitting the fragment and the authorization based on the fragment to a third edge-node. The third edge-node may be configured to store the fragment and the authorization based on the cached balance in a distributed ledger. To add the authorization into the distributed ledger, the third edge-node may obtain confirmation from the first and second edge-nodes. Confirmation may include executing a consensus protocol to determine whether the authorization should be recorded in the distributed ledger. In some embodiments, the consensus protocol may include the merchant POS system.

The cloud computing environment may be configured to synchronize the central ledger with an electronic payment recorded in the distributed ledger. Synchronization may include executing trades or other transactions based on information (e.g., price) entered when the cloud computing environment was unavailable. Synchronization may include mediating conflicts between entries recorded in the distributed ledger relative to entries recorded in the central ledger. Conflicts may be resolved based on attributes. For example, offline payments may include an attribute indicating the electronic payment was authorized by an edge-node. The central ledger may be configured to incorporate such offline payments and adjust customer balances and credit accordingly. The central ledger may determine whether an authorization for an electronic payment has been recorded elsewhere in the distributed ledger.

A third edge-node may be configured to try and connect with the cloud computing environment. The first and/or second edge-nodes may be configured to communicate to the cloud computing environment that an authorization decision for an offline payment has been made using a locally stored ledger fragment.

The first edge-node may not be able to locate a fragment of the central ledger that includes data associated with the customer. Nevertheless, the first edge-node may be configured to authorize the offline payment when goods are a high frequency staple good. The first edge-node may be configured to authorize the offline payment when a value associated with the goods is less than a predetermined limit associated with the customer account.

Whether goods qualify as high frequency staple goods may be determined based on information stored locally on the first edge-node. For example, the first edge-node may maintain a local log of electronic payments and associated attributes. Illustrative attributes associated with an electronic payment are shown above in Table 1.

A federated computer system is provided. The federated system may include a group of edge-nodes. The group of edge-nodes may communicate with a cloud computing environment. The cloud computing environment may provide an authorization decision for a payment request to debit a customer account. When making the authorization decision, the cloud computing environment may utilize data stored in a central ledger. The central ledger may store historical electronic payments and attributes associated with each electronic payment.

The cloud computing environment may not be accessible to a group of edge-nodes. For example, a natural disaster may damage communication infrastructure. In response to failure to communicate with the cloud computing environment, edge-nodes may autonomously form an authorization consortium. The authorization consortium may be configured to provide authorization decisions without access to the cloud computing environment and the data stored in the central ledger.

The authorization consortium may apply a consensus protocol to elect a first consortium member to provide recording-keeping functionality. In some embodiments, the authorization consortium may utilize the consensus protocol to provide recording-keeping functionality using distributed ledger technology. The consensus protocol may nominate a second consortium member to provide payment request authorization functionality.

The second consortium member may be configured to perform authorization services on behalf of other nodes in the consortium. Authorization services may include locating a fragment of the central ledger stored local on a third consortium member. The fragment may include locally stored information associated with a customer account. The fragment may include locally stored information associated with a customer's available line-of-credit. The first edge-node may be configured to locate a fragment based on one or more attributes included in an offline payment.

The second consortium member may issue an authorization decision for the offline payment based on information (e.g., attributes) included in the fragment. The second consortium member may transmit the fragment and authorization based on the fragment to the first consortium member. In response to receiving the authorization, the first consortium member may trigger release of the goods to the customer.

The cloud computing environment may be inaccessible to one or more edge-nodes. The cloud computing environment may be deemed unavailable when a threshold number of edge-nodes are each unable to communicate with the cloud computing environment within a predetermined time period. Each member of an authorization consortium may be configured to attempt to connect with the cloud computing environment before authorizing an offline payment based on the fragment.

An authorization consortium may be formed based on geographic location. The geographic location may be a location of a customer device that initiates the offline payment. The geographic location may be a location of edge-nodes included in the group and located within a predetermined distance of the customer device. An authorization consortium may be formed based on available network connectivity to one or more edge-node. An authorization consortium may be formed based on processing power of edge-nodes. An authorization consortium may be formed based on suitable factor that reduces latency in generating an authorization decision for an offline payment.

The second consortium member may not be able to locate a locally stored fragment of the central ledger that includes information for processing the offline payment. For example, locally stored fragments may not include attributes for the customer or specific merchant. Despite being unable to locate a fragment, the second consortium member may authorize the offline payment when goods associated with the offline payment are high frequency staple goods. Despite being unable to locate the locally stored fragment, the second consortium member may authorize the offline payment request when a value associated with the goods is less than a predetermined limit. The value limit may be determined based on a value of a high frequency staple good.

A high frequency staple good and associated value may be determined based on information stored locally on a member of the authorization consortium accessible to the second consortium member. For example, a determination of what qualifies as a high frequency staple good may vary from location to location. Likewise, a value of those high frequency staples goods may vary from location to location. A fragment, despite not having any attributes corresponding to a particular customer or merchant, may include attributes that indicate a particular item is a high frequency staple good in a particular locale.

Methods for resilient operation of a federated computer system are provided. Methods may include, at a cloud computing environment, receiving a first payment authorization request from an edge-node. Methods may include receiving the payment request from an edge-node such as a customer mobile device via near field communication (“NFC”).

In response to receiving the payment request, methods may include pushing to the edge-node a fragment of a central ledger stored in the cloud computing environment. Methods may include formulating a fragment based on one or more attributes associated with the payment request. For example, a fragment may be formulated that includes historical electronic payments that are associated with one or more attributes in common with the received payment request. Methods may include, at the edge-node, encrypting the fragment. The encryption may prevent inadvertent disclosure of information included in the fragment.

The fragment may be stored locally on an edge-node. A locally stored fragment may be available to an edge-node without a network connection to the cloud computing environment. The edge-node may detect when a second payment authorization request transmitted to the cloud computing environment times-out. When an authorization request submitted to the cloud computing environment times-out, methods may include the edge-node accessing the encrypted fragment. Methods may include authorizing the second and now offline payment based on the encrypted fragment.

In response to authorizing the second (offline) payment request based on the encrypted fragment, methods may include releasing goods associated with the second payment request. Methods may include synchronizing attributes of the first payment request and the second (offline) payment requests with the central ledger. Methods may include synchronizing authorizations of the first payment request and the second (offline) payment requests with the central ledger. Methods may include periodically attempting to connect to the cloud computing environment and synchronize with the central ledger.

Methods may include determining a storage destination for a fragment based on a geographic location of an edge-node. The fragment may be pushed to edge-nodes that are expected to process offline payments that include attributes in common with the fragment. The cloud computing environment, when connected to the edge-node, may push a fragment of the central ledger to the edge-node.

Methods may include determining a storage destination for a fragment based on a geographic zone associated with the edge-node. A fragment that includes geographic attributes within the zone may be stored on the edge-node. A geographic zone may be determined based on a predetermined distance from an edge-node or other known location. A geographic zone may be determined based on a location associated with an electronic payment request recorded in the ledger. The geographic zone may be determined based on an address associated with a customer account or line-of-credit. The cloud computing environment may attempt to store fragments on edge-nodes that are likely to process offline payments using data included in the fragment.

The edge-node may be a first edge-node. Methods may include detecting a time-out of a payment authorization request submitted by a second edge-node to the cloud computing environment. Methods may include accessing an encrypted fragment stored locally on the first edge-node. Methods may include authorizing the second payment request based on the encrypted fragment. Methods may include authorizing an offline payment anyway when the offline payment includes attributes that “fit” into a pattern of attributes includes in the fragment. In response to authorizing the second payment request based on the encrypted fragment, methods may include releasing goods associated with the second payment request.

Methods may include receiving, from a customer mobile device, confirmation that an offline payment has been authenticated using biometrics. For example, the first edge-node may be the customer mobile device and configured to capture and verify biometric credentials. In other embodiments, the first edge node may attempt to contact the customer mobile device and obtain biometric authentication before authorizing an offline payment request.

Methods may include the synchronizing offline payment requests authorized by an edge-node with payment requests authorized by the cloud computing environment. Synchronizing offline payment requests may include updating a central ledger. The central ledger may be configured to incorporate authorized offline payments and adjust customer balances and credit accordingly.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with another illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

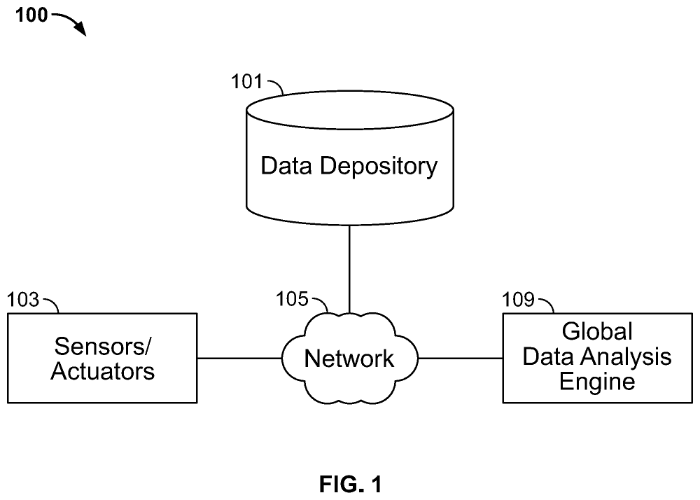

FIG. 1 shows illustrative system architecture 100. Architecture 100 may represent an illustrative IoT network. Architecture 100 may include one or more nodes. Each node may include two or more nodes. Nodes may be linked to each via network 105. FIG. 1 shows exemplary nodes 103 that include sensors and actuators. Nodes 103 may communicate with data analysis engine 109 and data depository 101. Data analysis engine 109 and data depository 101 may be included in a cloud computing environment. Data depository 101 may store a central ledger. Data analysis engine 109 may formulate fragments of the central ledger.

Nodes 103 may include sensors that detect changes in a physical or virtual environment. Sensors may measure changes in their native (physical or virtual) environment, capture data corresponding to the measured changes and store/communicate the captured data. Sensors may be accessed by other sensors or other network nodes. Sensors may transmit captured data to another node.

Nodes 103 may include actuators. Actuators may respond to data transmitted or processed by other nodes such as data analysis engine 109. Actuators may include devices that modify the physical state of a physical entity. Actuators may include devices that modify a virtual state of information. Actuators may move (translate, rotate, etc.) physical objects or activate/deactivate functionalities of physical objects. For example, actuators may dim a light bulb, open a door, change a temperature setting, authorize offline payments and/or any other suitable functionality. Actuators may verify identities, trigger electronic payments, extend credit or debit accounts. A single node may include the functions of sensors and actuators.

Generally, nodes on a network may interact and cooperate using one or more interaction paradigms. Exemplary interaction paradigms include master-slave, client-server and peer-to-peer interactions. As a result of the disparate nature of nodes 103, system architectures, such as architecture 100 incorporating nodes 103 may support a variety of communication protocols.

Typically, data captured by nodes 103 may be transmitted and processed far from the location where the data was captured. For example, captured data may be transmitted from one node to another node until the captured data reaches data depository 101.

Nodes 103 may be produced by different manufacturers. Nodes 103 may capture data in different formats. For example, nodes 103 may use different data structures to store captured data. Nodes 103 may utilize different communication protocols to transmit captured data or communicate with other nodes. Despite such operational differences, nodes 103 may be configured to operate substantially seamlessly together. Interoperability of nodes 103 may allow captured data to be substantially seamlessly captured and interpreted by data analysis engine 109 (or other nodes). Based on interpreting the captured data, data analysis engine 109 may issue instructions to nodes 103 and formulate fragments in a format that is understood by nodes 103.

Interoperability may be implemented across any suitable nodes of architecture 100. Interoperability may enable communication between nodes 103. Interoperability may enable architecture 100 to provide services and applications via nodes 103. Interoperability may allow services and content to be provided anywhere, anytime and based on input/output of nodes 103.

Data gathering by one or more of nodes 103 may be controlled by one or more other nodes. For example, data analysis engine 109 may control a quantity and/or quantity of data captured by nodes 103. Alternatively, data depository 101 and/or analysis engine 109 may filter or otherwise intelligently process data captured by nodes 103. One of nodes 103 may control data gathering or actuation of another of nodes 103.

Timing of when data is captured by nodes 103 may be controlled by any suitable node of architecture 100. For example, data may be captured in real-time or at pre-defined intervals such as once a day. Data may also be captured in response to a detected environmental status change.

Data analysis engine 109 may filter data captured by nodes 103. Data analysis engine 109 may repackage or reformat captured data. Data conversion may include transformation of low level raw data (possibly from multiple sensors or groups of sensors) into meaningful information for a specific audience or for a specific analysis. Captured data intended for human consumption or interaction may be converted into a human understandable format. Captured data intended for machine consumption may be converted into a format readable by a particular machine or node.

Data analysis engine 109 may perform pattern recognition to identify correlations and trends in captured data. For example, data analysis engine 109 may identify geographic or temporal trends in attributes stored in the central ledger. Based on the patterns, data analysis engine 109 may formulate a fragment to storage on nodes 103. Data depository 101 may receive data captured by nodes 103. In some embodiments, data captured by nodes 103 may be transmitted directly to data analysis engine 109. Data stored in depository 101 may be sorted and analyzed by data analysis engine 109. Data stored in data depository 101 may be so voluminous and complex (e.g., structured/unstructured and/or constantly changing) that traditional data processing application software may be inadequate to meaningfully process the data (e.g., “big data”). Data analysis engine 109 may include software applications specially designed to process large volumes of data (“big data analytics”).

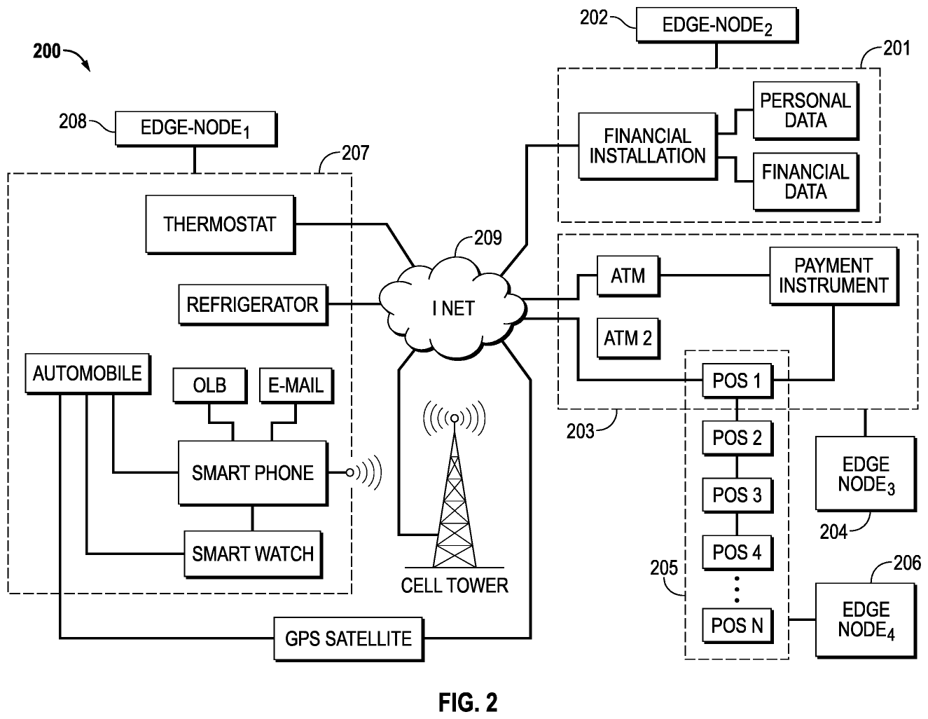

FIG. 2 shows illustrative node groups 200. Edge-node 208 is associated with group 207. Edge-node 208 may facilitate seamless communication among nodes of group 207. Edge-node 208 may facilitate secure communication among nodes of group 207. Based on data captured by nodes in group 207, edge-node 208 may formulate a request for a fragment of a central ledger that is expected to include information for authorizing offline payments. Edge-node 208 may locally store a fragment that includes attributes that are expected to be included in transactions generated by nodes in group 207.

Edge-node 202 is associated with group 201. Edge-node 202 may facilitate seamless communication among nodes of group 201. Edge-node 202 may facilitate secure communication among nodes of group 201. Edge-node 202 may locally store a fragment that includes attributes that are expected to be included in transactions generated by nodes in group 201.

Edge-node 204 is associated with group 203. Edge-node 204 may facilitate seamless communication among nodes of group 203. Edge-node 204 may facilitate secure communication among nodes of group 203. Edge-node 204 may locally store a fragment that includes attributes that are expected to be included in transactions generated by nodes in group 203.

Edge-node 206 is associated with group 205. Edge-node 206 may facilitate seamless communication among nodes of group 205. Edge-node 206 may facilitate secure communication among nodes of group 205. Edge-node 206 may locally store a fragment that includes attributes that are expected to be included in transactions generated by nodes in group 205.

A node in group 203 may request data captured by one or more nodes in groups 207 or 205. Such data may be leveraged to authenticate a customer. Such data may be leveraged to authorize an offline payment at a node of group 205, such as a point-of-sale (“POS”) terminal.

Edge-node 208 may identify communication pathways within group 207 to securely and efficiently transfer data between nodes of groups 203/205 and nodes of group 207. Edge-node 208 may facilitate direct communication between one or more nodes of groups 203/205 and one or more nodes of group 207. Edge-node 208 may obtain approval from edge-nodes 202/204 to facilitate such direct communication. Edge-node 208 may authenticate a customer based on data gathered by nodes 202/204.

A network or group of nodes may include two or more edge-nodes. A node may be configured to connect to an edge-node that is closest to it. A node may be configured to connect to an edge-node that is closest to it. “Closeness” may be defined based on geographic proximity. “Closeness” may be defined based on a length of a communication pathway (physical or virtual) that connects a node and an edge-node. “Closeness” may be defined based on a length of a communication pathway (physical or virtual) that connects a node and an edge-node. A length of a communication pathway may be defined based on a number of intermediary nodes between a node and an edge-node. A length of a communication pathway may be defined based on distance physically separating a node from an edge-node. An edge-node for processing an offline payment may be identified based on closeness to a source of the offline payment.

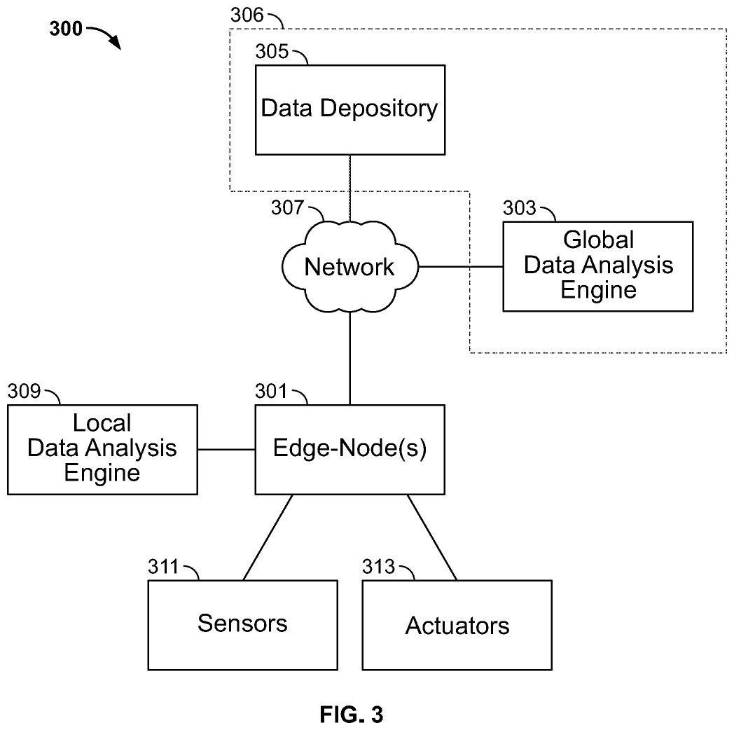

FIG. 3 shows illustrative system architecture 300. System 300 includes data depository 305 and global data analysis engine 303. Data depository 305 and global data analysis engine 303 may be included in cloud computing environment 306. Data depository 305 may store a central ledger. Global data analysis engine 303 may formulate fragments of the central ledger for storage on one or more edge-nodes. Global data analysis engine 303 may include payment request authorization software. Global data analysis engine 303 may be configured to authorize, based on the central ledger, a payment request to debit a customer account.

System 300 includes edge-node(s) 301. Edges-node(s) 301 may be configured to submit a payment request to cloud computing environment 306. Edge-node(s) 301 may be configured to receive an authorization decision from cloud computing environment 306.

When a connection is established linking cloud computing environment 306 and edge-node(s) 301, cloud computing environment 306 may push a fragment of the central ledger to edge-node(s) 301. The fragment of the central ledger may be stored in local data analysis engine 309. Local data analysis engine 309 may include computer executable instructions for authorizing an offline payment request based on the ledger fragment.

Cloud computing environment 306 may formulate a fragment to be pushed to edge-node(s) 301 based on group of nodes associated with edge-node(s) 301 (e.g., groups 207, 201, 203 and 205 shown in FIG. 2). A group of nodes associated with edge-node(s) 301 may capture data that provides criteria for formulating a relevant fragment. For example, captured data may include payment attributes or information that may be correlated to payment attributes. Cloud computing environment 306 may formulate a relevant ledger fragment for storage on edge-node(s) 301 based on the payment attributes gathered by the group of nodes associated with edge-node(s) 301.

A group of nodes associated with edge-node(s) 301 may be based on a geographic location of edge-node(s) 301. Such a group may be based on a closeness of nodes to edge-node(s) 301. Such a group may include sensors 311 and actuators 313. Sensors 311 and actuators 313 may be configured to locate edge-node(s) 301 when a connection to cloud computing environment 306 is unavailable.

When a connection cannot be established by edge-node(s) 301 or any node within the group associated with edge-node(s) 301, edge-node(s) 301 may utilize local data analysis engine 309 and a ledger fragment to authorize offline payments without communicating with cloud computing environment 306.

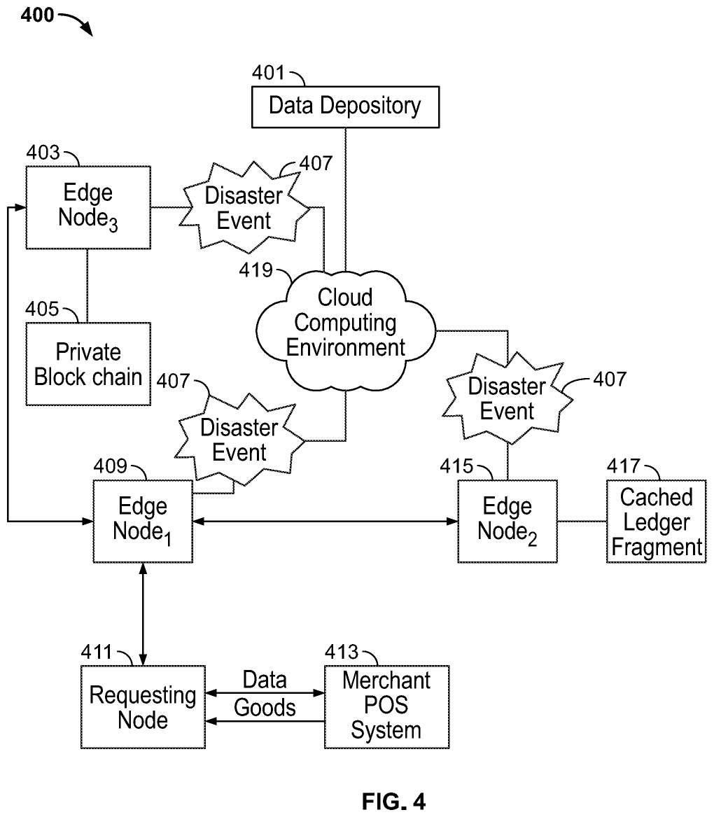

FIG. 4 shows operation of illustrative system components 400. Components 400 include cloud computing environment 419 and associated data depository 401. A central ledger may be stored in data depository 401.

FIG. 4 shows that node 411 and merchant POS system 413 may communicate.

Node 411 may submit a payment request. The payment request may be included in a purchase transaction to obtain goods/services. Merchant POS system 413 may release the desired goods/services when the payment request is authorized.

Typically, a payment request may be submitted to cloud computing environment 419 for processing. Cloud computing environment 419 may leverage information stored in data depository 401 to evaluate whether to authorize the payment request.

FIG. 4 shows that disaster event 407 may disrupt communication with cloud computing environment 419. As a result of disaster event 407, node 411 and/or merchant POS system 413 may be unable to communicate with cloud computing environment 419. Conventionally, if cloud computing environment 419 is unable to provide authorization, merchant POS system will not release the desired goods to the customer.

FIG. 4 shows that despite a communication disruption caused by disaster event 407, node 411 may initiate communication with edge-node 409. Node 411 may submit an offline payment request to edge-node 409. Edge-node 409 may attempt to locate a ledger fragment that includes information for authorizing the offline payment request. Information for authorizing an offline payment may include a record of a customer account balance, available credit, transaction activity, patterns in the customer's transaction attributes and any other suitable attribute shown in Table 1 or pattern of those attributes.

Edge-node 409 may locate the ledger fragment based on a location of node 411, merchant POS system 413, data captured by a group that includes node 411 or payment attributes included in the offline payment. Illustrative payment attributes are shown above in Table 1.

FIG. 4 shows that edge-node 415 includes cached ledger fragment 417. Cached ledger fragment 417 may include a record of a customer account balance, available credit, transaction activity, patterns in the customer's transaction attributes and other attributes associated with historical electronic payments. Cached ledger fragment 417 may have been pushed to edge-node 415 by cloud computing environment 419 prior to disaster events 407.

Edge-node 415 may be configured to authorize an offline payment request based on cached ledger fragment 417. The authorization decision provided by edge-node 415 may communicated to merchant POS system 413 via edge-node 409 and requesting node 411. In some embodiments, edge-node 415 or edge-node 409 may communicate directly with merchant POS system 413. In response to receiving authorization, merchant POS system 413 may release goods to node 411.

An authorization decision provided by edge-node 415 may be communicated to edge-node 403. Edge-node 403 may record the authorization decision in private blockchain 405. Private blockchain 405 may be synchronized with data depository 401 when connections are available to cloud computing environment 419.

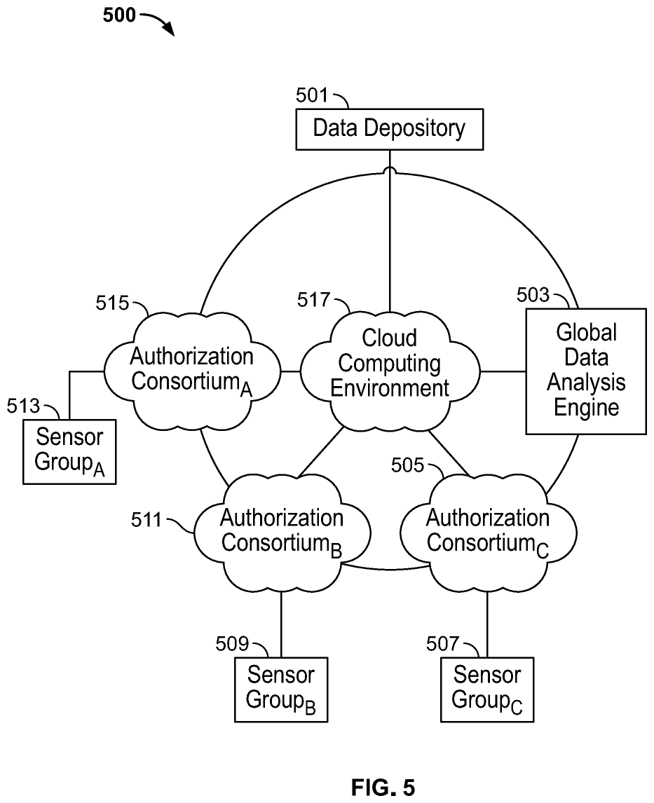

FIG. 5 shows illustrative system architecture 500. System 500 includes cloud computing environment 517 and associated data depository 501. Data depository 501 may store a central ledger. Cloud computing environment 517 may be configured to receive payment requests from node groups 513, 509 and 507. Global data analysis engine 503 may provide authorization software for processing payment requests received from node groups 513, 509 and 507 based on the central ledger.

However, node groups 513, 509 and 507 may not be able to communicate with cloud computing environment 517. For example, a disaster event may disrupt communication with between node groups 513, 509 and 507 and cloud computing environment 517.

In response to a communication disruption, FIG. 5 shows that node groups 513, 509 and 507 autonomously form authorization consortiums 515, 511 and 505. Each authorization consortium may be formed based on closeness between nodes. Each of node groups 513, 509 and 507 may apply a consensus protocol to elect a first consortium member to provide recording-keeping functionality for the consortium and a second consortium member to provide payment request authorization functionality for the consortium.

The second consortium member may be configured to locate a fragment of the central ledger stored locally on a third consortium member. The central ledger fragment may include information for authorizing an offline payment request. Illustrative information may include a record of a customer account balance, available credit, transaction activity, patterns in the customer's transaction attributes and any other suitable attributes shown in Table 1. The second consortium member may process the offline payment and transmit an authorization decision to the first consortium member.

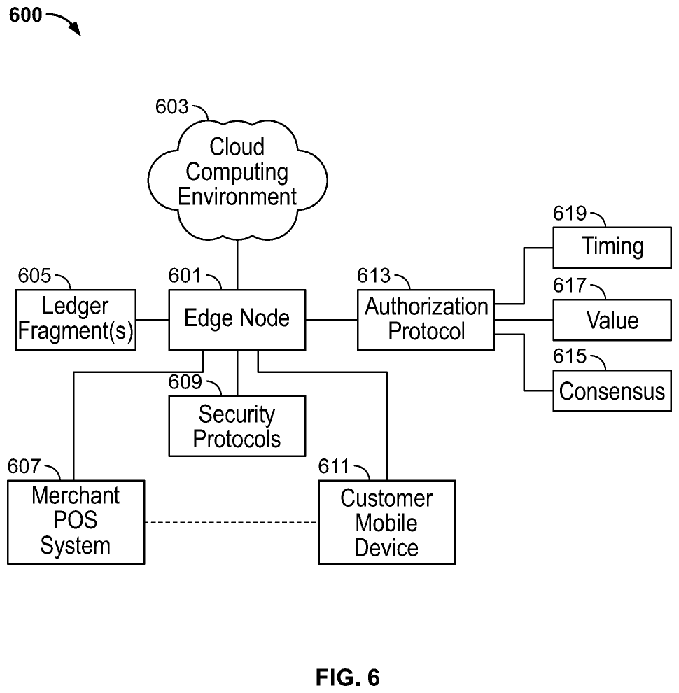

FIG. 6 shows illustrative system components 600. Components 600 include cloud computing environment 603. Components 600 include edge-node 601. Components 600 include merchant POS system 607 and customer mobile device 611.

Customer mobile device 611 may submit a payment request to merchant POS system 607. Merchant POS system 607 (or customer mobile device 611) may attempt to submit the payment request to cloud computing environment 603 for authorization processing. If attempts to connect cloud computing environment 603 timeout, an offline payment request may be submitted to edge-node 601.

Edge-node 601 may execute authorization protocol 613 and attempt to authorize the offline payment request based on information associated with ledger fragment 605. Ledger fragment 605 may include a record of a customer account balance, credit available to the customer, historical transaction activity, patterns in the customer's historical transaction attributes and any other suitable attributes shown in Table 1. Ledger fragment 605 may be stored locally on edge-node 601.

Edge-node 601 may apply security protocols 609 to ensure validity of an offline payment request. For example, edge-node 601 may request that customer mobile device validate the offline payment request using biometric credentials.

Authorization protocol 613 may utilize consensus protocol 615 to confirm that an offline payment will be recorded in a distributed ledger before issuing an authorization decision. The consensus protocol may allow a consortium to locate reliable and relevant fragments of a central ledger stored locally on an edge-node. The consensus protocol may allow the edge-node members of the consortium to leverage their collective functionality, such as processing power, to process offline payment requests.

Authorization protocol 613 may evaluate an offline payment request based on an attribute of the offline payment request such as value 617. Authorization protocol 613 may evaluate an offline payment request based on timing 619. Timing 619 may refer to a “freshness” of ledger fragment 605. For example, if ledger fragment 605 has not been updated by cloud computing environment 603 within a predetermined time from a disaster event, edge-node 601 may only authorize offline payment requests for low value, high frequency goods.

Timing 619 may refer to a frequency of offline payment requests. Timing 619 may set limit for a number of offline payment requests that may be authorized by edge-node 609. The limit may be associated with customer mobile device 611 or merchant POS system 607 or any other suitable payment attribute shown above in Table 1.

In some embodiments, even when a connection is available to cloud computing environment 603, payment requests may be initially routed to edge-node 601 for processing. Edge-node 601 may also attempt to authorize a payment request based on ledger fragment 605. Allowing edge-node 601 to provide authorization decisions for online payment requests may reduce latency in obtaining an authorization decision. Allowing edge-node 601 t to provide authorization decisions for online payment requests may reduce data traffic received by cloud computing environment 603. Allowing edge-node 601 t to provide authorization decisions for online payment requests may reinforce or harden authorization decisions issued by cloud computing environment 603.

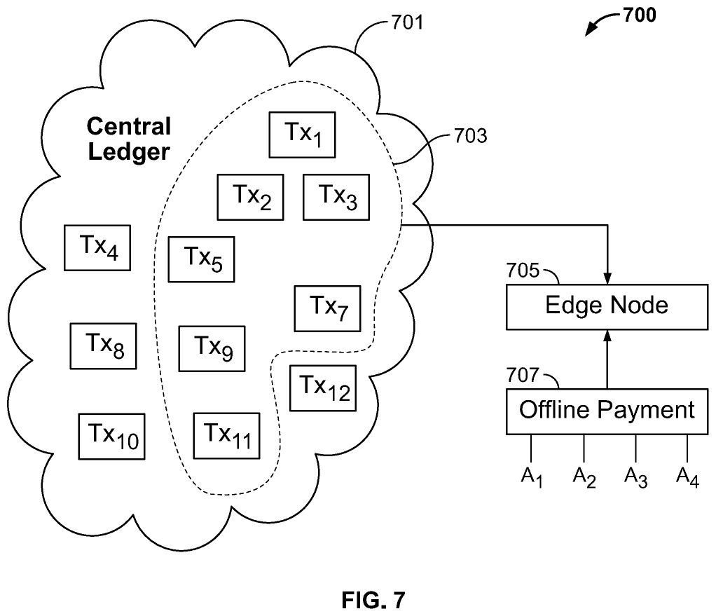

FIG. 7 shows illustrative authorization process 700. FIG. 7 shows central ledger 701 storing records of transactions Tx₁₋₁₂. Each of transactions Tx₁₋₁₂ may be associated with one or more attributes. Illustrative attributes are shown above in Table 1. Fragment 703 of central ledger 701 may be stored locally on edge-node 705. Fragment 703 includes records of transactions Tx_{1, 2, 3, 5, 7, 9 and 11}. A cloud computing environment may select transactions to be included in fragment 703 based on transactions having attributes that are correlated to edge-node 705. Illustrative correlations may include location of a customer, location of a merchant, goods sold by a merchant and goods purchased by a customer.

Edge-node 705 may evaluate and authorize offline payment 707 based on correlating payment attributes A₁₋₄ of offline payment 707 and payment attributes associated with Tx_{1, 2, 3, 5, 7, 9 and 11} stored in fragment 703. For example, when a correlation indicates that other authorized transactions stored in fragment 703 have attributes within a predefined range of attributes A₁₋₄, edge-node 705 may authorize offline payment 707.

Thus, apparatus and methods for a FEDERATED EDGE-NODE AUTHORIZATION SYSTEM are provided. Persons skilled in the art will appreciate that the present disclosure can be practiced by other than the described embodiments, which are presented for purposes of illustration rather than of limitation. The present disclosure is limited only by the claims that follow.

What is claimed is:

1. A method for resilient operation of a federated computer system, the method comprising:
at a cloud computing environment, receiving a first payment authorization request from an edge-node;
in response to receiving the payment request, pushing to the edge-node a fragment of a central ledger stored in the cloud computing environment;
encrypting the fragment;
storing the encrypted fragment locally on the edge-node;
the edge-node detecting a time-out of a second payment authorization request transmitted to the cloud computing environment;
accessing the encrypted fragment and authorizing the second payment request based on the encrypted fragment;
in response to authorizing the second payment request based on the encrypted fragment, releasing goods associated with the second payment request; and
synchronizing the first payment request and the second payment request with the central ledger.

2. The method of claim 1 further comprising locating the fragment pushed to the edge-node based on a geographic location of the edge-node and geographic information associated with the first fragment.

3. The method of claim 1, wherein the edge-node is a first edge-node, the method further comprising:
detecting a time-out of a payment authorization request submitted by a second edge-node to the cloud computing environment;
accessing the encrypted fragment stored locally on the first edge-node and authorizing the second payment request based on the encrypted fragment; and
in response to authorizing the second payment request based on the encrypted fragment, releasing the goods associated with the second payment request.

4. The method of claim 1 further comprising receiving the payment request from a customer mobile device via near field communication.

5. The method of claim 4 further comprising:
authenticating the payment request by validating a biometric credential using the customer mobile device; and
receiving confirmation from the customer mobile device that the payment request has been authenticated.

6. The method of claim 1 further comprising synchronizing payment requests authorized based on the encrypted fragment with the central ledger stored in the cloud computing environment.

7. A federated computer system comprising a group of edge-nodes configured to communicate with a cloud computing environment and authorize payment requests to debit a customer account based on a central ledger and, when the cloud computing environment is inaccessible to the group of edge-nodes:
the group of edge-nodes autonomously forms an authorization consortium;
the group of edge-nodes apply a consensus protocol to elect:
a first consortium member to provide recording-keeping functionality for the consortium; and
a second consortium member to provide payment request authorization functionality for the consortium;
wherein the second consortium member is configured to:
locate a fragment of the central ledger stored locally on a third consortium member, the fragment comprising information associated with the customer account;
authorize the payment request based on the information in the fragment;
transmit the fragment and an authorization decision based on the fragment to the first consortium member; and
trigger a release of goods.

8. The federated computer system of claim 7, wherein the cloud computing environment is determined to be inaccessible to the group of edge-nodes when a threshold number of edge-nodes in the group are each unable to establish a communication path to the cloud computing environment within a predetermined time period.

9. The federated computer system of claim 8, wherein each member of the authorization consortium is configured to attempt to establish the communication path to the cloud computing environment before releasing the goods in response to receiving the authorization decision based on the fragment.

10. The federated computer system of claim 7, wherein the authorization consortium is formed based on a geographic location of:
a customer device that initiates the payment request; and
edge-nodes included in the group and located within a predetermined distance of the customer device.

11. The federated computer system of claim 7, wherein when the second consortium member cannot locate the fragment of the central ledger, the second consortium member is configured to authorize the payment request when:
the goods associated with the payment request are a high frequency staple good; and
a value associated with the goods is less than a predetermined limit associated with the customer account;
wherein, the high frequency staple good and the value are determined based on information stored locally on a member of the authorization consortium accessible to the second consortium member.

12. A federated computing system that provides a technical solution to a communication disruption among components of the federated computing system, the federated computing system comprising:
a cloud computing environment comprising:
a central ledger; and
payment request authorization software configured to authorize, based on the central ledger, a payment request to debit a customer account;
a first edge-node configured to:
receive the payment request;
transmit the payment request to the cloud computing environment;
when the cloud computing environment acknowledges receipt of the payment request within a predetermined time period:
wait to receive authorization from the payment request authorization software; and
in response to receiving authorization for the payment request from the cloud computing environment, release goods associated with the payment request; and
when the cloud computing environment fails to acknowledge receipt of the payment request within the predetermined time period:
locate a second edge-node storing a fragment of the central ledger, the fragment comprising a cached balance associated with the customer account;
authorize the payment request based on the cached balance; and
release the goods in response to authorizing the payment request based on the cached balance.

13. The federated computer system of claim 12 wherein when the when the cloud computing environment fails to acknowledge receipt of the payment request within a predetermined time period, the first edge-node is configured record authorization of the payment request based on the cached balance by transmitting the fragment and the authorization based on the cached balance to a third edge-node.

14. The federated computer system of claim 13, wherein, the third edge-node is configured to store the fragment and the authorization based on the cached balance in a distributed ledger.

15. The federated computer system of claim 14, wherein the cloud computing environment is configured to synchronize the central ledger with the distributed ledger.

16. The federated computer system of claim 12, wherein:
the cloud computing environment imposes a first set of restrictions when authorizing the payment request based on the central ledger; and
the first edge-node is configured to impose a second set of restrictions when authorizing the payment request based on the cached balance.

17. The federated computer system of claim 16, wherein the second set of restrictions comprises a limit on a value of the goods.

18. The federated computer system of claim 16, wherein the second set of restrictions comprises a limit on a number of payment requests that may be authorized based on the cached balance.

19. The federated computer system of claim 16, wherein the second set of restrictions comprises a limit on a geographic location of the first edge-node.

20. The federated computer system of claim 12, wherein when the first edge-node cannot locate the fragment of the central ledger, the first edge-node is configured to authorize the payment request when:
the goods are a high frequency staple good; and
a value associated with the goods is less than a predetermined limit associated with the customer account;
wherein, the high frequency staple good and the value are determined based on payment attributes stored locally on the first edge-node.
